(19) United States
(12) Patent Application Publication
(10) Pub. No.: US 2024/0306249 A1
(43) Pub. Date: Sep. 12, 2024

(54) CONNECTION CONTROL METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventor: Jiangsheng FAN, Dongguan (CN)

(21) Appl. No.: 18/658,483

(22) Filed: May 8, 2024

Related U.S. Application Data
(63) Continuation of application No. PCT/CN2021/129642, filed on Nov. 9, 2021.

(51) Int. Cl. H04W 76/30

(52) U.S. Cl. CPC H04W 76/30

(57) ABSTRACT

A connection control method, a terminal device, a network device, a chip, a computer readable storage medium, a computer program product, a computer program, and a communication system are provided. The method includes that: a terminal device sends a first message to a network device, wherein the first message is used for requesting the release or suspension of the connection to a first cell, and the first cell includes a DC cell and/or a CA cell.

### CROSS-REFERENCE TO RELATED APPLICATION

This is a continuation application of International Patent Application No. PCT/CN2021/129642, filed on Nov. 9, 2021, entitled “CONNECTION CONTROL METHOD, TERMINAL DEVICE AND NETWORK DEVICE”, the disclosure of which is hereby incorporated by reference in its entirety.

### BACKGROUND

With the development of communication technologies, many terminal devices (such as mobile phones) have the function of supporting multiple Subscriber Identification Module (SIM) cards. These terminal devices can be called multi-card terminal devices. Multiple cards in a multi-card terminal device share wireless processing resources of the terminal. It is necessary to consider how to coordinate the wireless processing resources of the terminal.

### SUMMARY

The present disclosure relates to the field of communications, and more particularly to a method for connection control, a terminal device, a network device, a chip, a computer readable storage medium, a computer program product, a computer program and a communication system.

In view of this, embodiments of the present disclosure provide a method for connection control, a terminal device, a network device, a chip, a computer readable storage medium, a computer program product, a computer program, and a communication system.

An embodiment of the present disclosure provides a method for connection control, which includes the following operation.

A terminal device sends a first message to a network device. The first message is used to request a release or suspension of a connection with at least one first cell, and the at least one first cell includes at least one Dual Connectivity (DC) cell and/or at least one Carrier Aggregation (CA) cell.

An embodiment of the present disclosure further provides a terminal device, including a processor and a memory, where the memory is used for storing a computer program, and the processor is configured to call and run the computer program stored in the memory to cause the terminal device to: send a first message to a network device, wherein the first message is used to request a release or suspension of a connection with at least one first cell, and the at least one first cell comprises at least one Dual Connectivity (DC) cell and/or at least one Carrier Aggregation (CA) cell.

An embodiment of the present disclosure further provides a network device, including a processor and a memory, where the memory is used for storing a computer program, and the processor is configured to call and run the computer program stored in the memory to cause the network device to: receive a first message from a terminal device, wherein the first message is used to request a release or suspension of a connection with at least one first cell, and the at least one first cell comprises at least one Dual Connectivity (DC) cell and/or at least one Carrier Aggregation (CA) cell.

### BRIEF DESCRIPTION OF THE DRAWINGS

FIG. 1 is a schematic diagram of architecture of a communication system according to an embodiment of the present disclosure.

FIG. 2 is a schematic flowchart of a method for connection control according to an embodiment of the present disclosure.

FIG. 3 is a schematic flowchart of a method for connection control according to another embodiment of the present disclosure.

FIG. 4 is a schematic flowchart of a method for connection control according to yet another embodiment of the present disclosure.

FIG. 5 is a schematic block diagram of a structure of a terminal device according to an embodiment of the present disclosure.

FIG. 6 is a schematic block diagram of a structure of a terminal device according to another embodiment of the present disclosure.

FIG. 7 is a schematic block diagram of a structure of a network device according to an embodiment of the present disclosure.

FIG. 8 is a schematic block diagram of a structure of a network device according to another embodiment of the present disclosure.

FIG. 9 is a schematic block diagram of a communication device according to an embodiment of the present disclosure.

FIG. 10 is a schematic block diagram of a chip according to an embodiment of the present disclosure.

FIG. 11 is a schematic block diagram of a communication system according to an embodiment of the present disclosure.

### DETAILED DESCRIPTION

Technical solutions in embodiments of the present disclosure will be described below with reference to the drawings in the embodiment of the present disclosure.

The technical solutions of the embodiment of the present disclosure can be applied to various communication systems, such as: Global System of Mobile communication (GSM) systems, Code Division Multiple Access (CDMA) systems, Wideband Code Division Multiple Access (WCDMA) systems, General Packet Radio Service (GPRS), Long Term Evolution (LTE) systems, Advanced long term evolution (LTE-A) systems, New Radio (NR) systems, evolution systems of NR systems, and LTE-based access to unlicensed spectrum (LTE-U) systems, NR-based access to unlicensed spectrum (NR-U) systems, Non-Terrestrial Network (NTN) systems, Universal Mobile Telecommunication Systems (UMTS), Wireless Local Area Networks (WLAN), Wireless Fidelity (WiFi), 5th-Generation (5G) systems or other communication systems.

In general, traditional communication systems support a limited number of connections and are easy to implement. However, with the development of technologies of the communication, mobile communication systems will not only support traditional communication, but also support, for example, Device to Device (D2D) communication, Machine to Machine (M2M) communication, Machine Type Communication (MTC), Vehicle to Vehicle (V2V) communication, or Vehicle to everything (V2X) communication, etc. The embodiments of the present disclosure can also be applied to these communication systems.

Optionally, the communication system in the embodiments of the present disclosure can be applied to a Carrier Aggregation (CA) scenario, a Dual Connectivity (DC) scenario, and a Standalone (SA) network distribution scenario.

The embodiments of the present disclosure are described in connection with a network device and a terminal device. The terminal device may also be referred to as User Equipment (UE), an access terminal, a subscriber unit, a subscriber station, a mobile station, a mobile platform, a remote station, a remote terminal, a mobile device, a user terminal, a terminal, a wireless communication device, a user agent or a user device, etc.

The terminal device may be a STAION (ST) in a WLAN, a cellular telephone, a cordless telephone, a Session Initiation Protocol (SIP) telephone, a Wireless Local Loop (WLL) station, a Personal Digital Assistant (PDA) device, a handheld device having a wireless communication function, a computing device or other processing device connected to a wireless modem, a vehicle-mounted device, a wearable device, a terminal device in a next generation communication system, such as an NR network, or a terminal device in a future evolved Public Land Mobile Network (PLMN), etc.

In the embodiments of the present disclosure, the terminal device may be deployed on land including indoors or outdoors, and may be hand-held, wearable or vehicle-mounted. The terminal device can also be deployed on the water (such as ships, etc.). The terminal device can also be deployed in the air (such as airplanes, balloons and satellites, etc.).

In the embodiments of the present disclosure, the terminal device may be a Mobile Phone, a Pad, a computer with wireless transceiver function, a Virtual Reality (VR) terminal device, an Augmented Reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home), etc.

By way of example but not limitation, in the embodiments of the present disclosure, the terminal device may also be a wearable device. The wearable device can also be called a wearable intelligent device, which is a general name of wearable devices (such as glasses, gloves, watches, clothing and shoes) developed by intelligently designing daily wear by applying wearable technologies. The wearable device is a portable device that is worn directly on the body or integrated into the user's clothes or accessories. The wearable device is not only a kind of hardware device, but also realizes powerful functions through software support, data interaction and cloud interaction. The generalized wearable smart device includes devices that have full functions and a large size, which can realize complete or partial functions without relying on smart phones, such as smart watches or smart glasses. In addition, the generalized wearable smart device further includes devices that only focus on a certain kind of application function, which need to be used in conjunction with other devices, such as smart phones, such as various smart bracelets and smart jewelry for monitoring physical signs.

In the embodiments of the present disclosure, the network device may be a device for communicating with a mobile device. The network device may be an Access Point (AP) in a WLAN, a Base Transceiver Station (BTS) in a GSM or CDMA, a NodeB (NB) in a WCDMA, an Evolutional Node B (eNB or eNodeB) in a LTE, a relay station or an Access Point, a vehicle-mounted device, a wearable device, a network device (gNB) in an NR network or a network device in a future evolved PLMN network, etc.

The network device may also be a core network device, such as other network entities such as a Mobility Management Entity (MME), an Access and Mobility Management Function (AMF), etc. The embodiments of the present disclosure are not limited thereto.

By way of example but not limitation in the embodiments of the present disclosure, the network device may have mobility characteristics. For example, the network device may be a mobile device. Optionally, the network device can be a satellite or a balloon station. For example, the satellite may be a low earth orbit (LEO) satellite, a medium earth orbit (MEO) satellite, a geostationary earth orbit (GEO) satellite, a High Elliptical Orbit (HEO) satellite, and the like. Optionally, the network device can also be a base station arranged on land, water area and the like.

In the embodiments of the present disclosure, the network device can provide services for a cell, and the terminal device communicates with the network device through transmission resources (e.g., frequency domain resources, or spectrum resources) used by the cell. The cell can be a cell corresponding to the network device (e.g., base station), and the cell can belong to a macro base station or a base station corresponding to a Small cell. The Small cell can include a Metro cell, a Micro cell, a Pico cell, a Femto cell, etc. These small cells have the characteristics of small coverage and low transmission power, and are suitable for providing high-speed data transmission services.

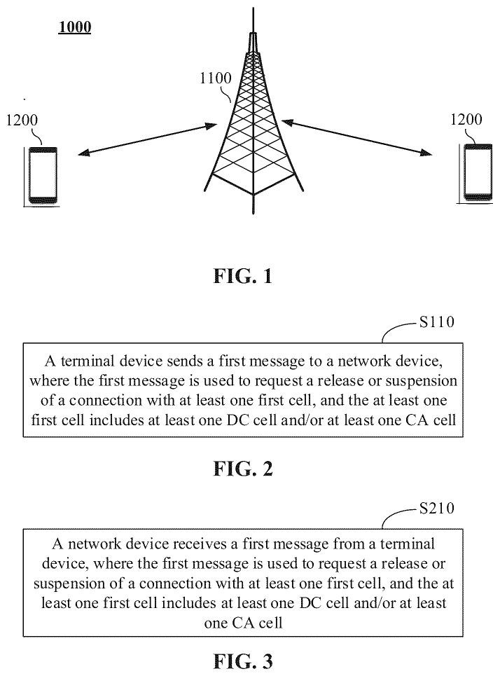

FIG. 1 schematically illustrates a wireless access system 1000 including one network device 1100 and two terminal devices 1200. Optionally, the wireless communication system 1000 may include multiple network devices 1100, and a coverage area of each network device 1100 may include other numbers of terminal devices, which are not limited by the embodiments of the present disclosure.

It should be understood that a device having a communication function in a network/system in the embodiments of the present disclosure may be referred to as a communication device. Taking the communication system illustrated in FIG. 1 as an example, the communication device may include a network device and terminal devices that have communication functions. The network device and the terminal devices may be specific devices in the embodiments of the present disclosure and will not be described herein.

It should be understood that the terms “system” and “network” are often used interchangeably herein. The term “and/or” herein is only an association relationship describing associated objects. For example, the term “and/or” means that there may be three relationships for associated objects before and after the term “and/or”. For example, “A and/or B” may have three meanings: A exists alone, A and B exist at the same time and B exists alone. The character “/” herein generally indicates that the associated objects before and after the character “/” are in an “or” relationship.

It should be understood that, the term “indication” referred to in the embodiments of the present disclosure may be a direct indication, an indirect indication, or an indication indicates that there is an association. For example, “A indicates B” means that A directly indicates B. For example, B can be obtained through A. “A indicates B” can also mean that A indirectly indicates B. For example, A indicates C, and B can be obtained by C. “A indicates B” can also indicate that there is an association between A and B.

In the description of the embodiments of the present disclosure, the term “correspondence” may mean that there is a direct correspondence or an indirect correspondence relationship between the two, may also mean that there is an association relationship between the two, may also be a relationship between indication and being indicated, configuration and being configured, etc.

In order to facilitate understanding of the technical solutions of the embodiments of the present disclosure, the following related technologies of the embodiments of the present disclosure are described, and the following related technologies can serve as an optional solution which can be arbitrarily combined with the technical solutions of the embodiments of the present disclosure, all of which belong to the protection scope of the embodiments of the present disclosure.

### (1) Overview of 5G Technology

At present, with people's pursuit of speed, delay, high-speed mobility and energy efficiency, as well as the diversity and complexity of services in future life, the 5G technology has developed rapidly. The main application scenarios of 5G include Enhanced Mobile Broadband (eMBB), Ultra Reliable Low Latency Communications (URLLC), massive Machine Type Communications (mMTC) and so on.

The eMBB still aims at users' access to multimedia contents, services and data, and the demand of the eMBB is growing rapidly. On the other hand, since the eMBB may be deployed in different scenarios, such as indoor, urban and rural areas, capabilities and requirements of the eMBB are quite different, which cannot be generalized and must be analysed in detail in combination with specific deployment scenarios. Typical applications of the URLLC include: industrial automation, power automation, telemedicine operation (surgery), traffic safety and so on. The typical characteristics of the mMTC include: high connection density, small data volume, delay-insensitive services, low cost and long service life of modules.

In 5G network environments, a new Radio Resource Control (RRC) state, RRC_INACTIVE, is defined for the purpose of reducing air interface signaling, and quickly restoring wireless connections and data services. The RRC_INACTIVE state is different from the RRC_IDLE and the RRC CONNECTED.

The RRC_IDLE: mobility is UE-based cell selection and reselection, paging is initiated by a Core Network (CN), and a paging area is configured by the CN. There is no UE Access Stratum (AS) context at a base station side, and there is no RRC connection.

The RRC CONNECTED: there is an RRC connection, and the UE AS context exists between the base station and UE. The network side knows that the location of the UE is at the specific cell level. Mobility is the mobility controlled by the network side. Unicast data can be transmitted between the UE and the base station.

The RRC_INACTIVE: mobility is UE-based cell selection and reselection, there is a connection between a core network and a Radio Access Network (RAN), the UE AS context exists on an anchor base station, paging is triggered by an RAN, an RAN-based paging area is managed by the RAN, and the network side knows that the location of the UE is at the RAN-based paging area level.

### (2) Multi-Card Terminal

Dual-card and dual-standby means that a terminal, such as a mobile phone, can support two number cards of different operators' networks at the same time, and make the two number cards in a start-up state at the same time, so that users can dial, answer calls or send and receive short messages at will without switching networks.

The dual USIM (Universal Subscriber Identity Module) card terminal is a major development trend. However, the current terminal capability generally does not support pure Dual UL/DL, that is, UE can simultaneously carry out uplink and downlink data services on two networks through two SIM cards. Generally speaking, most terminals at present only support Single UL/DL or Single UL/Dual DL, which means that the UE can only execute the service on one SIM card at a certain moment.

A dual-active multi-card terminal has at least two transmitting antennas and two receiving antennas at the same time, and the terminal with this type allows both two cards to enter the connected state.

In 5G, in dual-card dual-standby or dual-network dual-standby, one of two USIM cards can reside in an LTE cell and the other can reside in an NR cell, or both USIM cards can reside in the NR cell. Moreover, the two USIM cards can be the same operator or different operators.

The concept of the multi-card terminal can be explained in a similar logic for explaining the above dual-card, and thus will not be repeated here.

The DC/CA function has certain requirements for capabilities of the terminal device. Theoretically, as long as the capabilities of the terminal device meet the requirements, every SIM card of the multi-card terminal device can support the DC/CA function. However, since different SIM cards of the multi-card terminal device share a set of terminal hardware devices, i.e., the capabilities of the terminal device are shared among multiple SIM cards, it is likely that functions of the multiple SIM cards cannot be simultaneously satisfied. For example, the terminal device has only two transmitting antennas and two receiving antennas. If the card A is in the DC/CA operating state (two transmitting antennas and two receiving antennas are required) and the card B also wants to enter the connected state (one transmitting antenna and one receiving antenna are required), the function of the card B cannot be satisfied at the same time. It is necessary to consider how to coordinate terminal resources.

The solutions provided by the embodiments of the present disclosure are mainly used for solving at least one of the above problems.

In order to enable a more detailed understanding of the features and technical contents of the embodiments of the present disclosure, the implementation of the embodiments of the present disclosure will be described in detail below in conjunction with the accompanying drawings, which are provided for illustration only and are not intended to limit the embodiments of the present disclosure.

FIG. 2 is a schematic flowchart of a method for connection control according to an embodiment of the present disclosure. The method can optionally be applied to the system illustrated in FIG. 1, but is not limited thereto. The method includes the following operation.

In S110, a terminal device sends a first message to a network device. The first message is used to request a release or suspension of a connection with at least one first cell, and the at least one first cell includes at least one Dual Connectivity (DC) cell and/or at least one Carrier Aggregation (CA) cell.

In the embodiments of the present disclosure, the first cell may include the DC cell or the CA cell, or the first cell may include both the DC cell and the CA cell. Exemplarily, the DC cell may include a primary Secondary Cell Group (SCG) cell (PSCell) and/or a Secondary Cell (SCell), and the CA cell may include the SCell. Accordingly, the first cell may include the PSCell and/or the SCell, or the first cell may include one or more of cells with which the terminal device is connected other than the Primary Cell (PCell).

Exemplarily, the first message may be used to request a release or suspension of a connection with at least one DC cell or to request a release or suspension of a connection with at least one CA cell. The first message may also be used to request a release or suspension of a connection with at least one DC cell and to request a release or suspension of a connection with at least one CA cell.

Optionally, after releasing the connection with the first cell, the terminal device and the network device may delete configuration information associated with the cell.

Optionally, after suspending the connection with the first cell, the terminal device and the network device may retain configuration information associated with the cell, and the terminal device or the network device may trigger a cell connection restoration process, thereby allowing the terminal device to restore the connection with the cell that has been suspended.

According to the method, the terminal device can send the first message to the network device to request a release or suspension of a connection with the DC cell and/or the CA cell, so that the connection with the DC cell and/or the CA cell can be released or suspended according to the requirement of the terminal device, which is beneficial to the flexible coordination of the wireless processing resources of the terminal and meets different service requirements. For example, hardware resources of the multi-card terminal device can be flexibly shared among multiple SIM cards, which not only meets the different service requirements among the multiple cards, but also greatly reduces service interruption of each card, thus improving the user experience of the multi-card terminal device.

It should be noted that the terminal device in the embodiment of the present disclosure may be a multi-card terminal device or a single-card terminal device. The multi-card terminal device includes at least two SIM cards, such as a card A and a card B. When the card A is in a connected state, the card B can be in a connected state, an idle state or an inactive state. In a scenario where the terminal device is the multi-card terminal device, the terminal device can initiate a request to release or suspend a connection with the DC/CA cell based on the related requirements of multi-card shared terminal resources. In a scenario where the terminal device is the single-card terminal device, the terminal device can initiate a request to release or suspend a connection with the DC/CA cell based on resource usage. That is to say, the method of the embodiments of the present disclosure can be used not only to solve the terminal resource coordination problem of the multi-card terminal device, but also to solve the terminal resource coordination problem of any terminal device.

Accordingly, the embodiment of the present disclosure further provides a method for connection control for a network side to process the first message. FIG. 3 is a schematic flowchart of a method for connection control according to another embodiment of the present disclosure. The method can optionally be applied to the system illustrated in FIG. 1, but is not limited thereto. The method includes the following operation.

In S210, a network device receives a first message from a terminal device. The first message is used to request a release or suspension of a connection with at least one first cell, and the at least one first cell includes at least one Dual Connectivity (DC) cell and/or at least one Carrier Aggregation (CA) cell.

For the implementation of the first message, reference may be made to the following examples.

### First Example

The first message may include at least one of:
first indication information for indicating to the network device that a connection with all of the at least one first cell is to be released;
second indication information for indicating to the network device that a connection with all of the at least one first cell is to be suspended;
third indication information for indicating to the network device that a connection with a part of the at least one first cell is to be released and/or a connection with a part of the at least one first cell is to be suspended;
first list information including at least one cell identifier of at least one first cell with which the terminal device requests a release of a connection; or
second list information including at least one cell identifier of at least one first cell with which the terminal device requests a suspension of a connection.

For example, the first message may contain only the first indication information for releasing a connection with all of DC cells and/or all of CA cells. The terminal device notifies the network device through the first indication information that a connection with all of DC cells and/or all of CA cells established by the terminal device is to be released, or a connection with all of remaining PSCell cells and/or all of remaining SCell cells is to be released, except for keeping a connection between the terminal device and a PCell cell.

As another example, the first message may contain only the second indication information for suspending a connection with all of DC cells and/or all of CA cells. The terminal device notifies the network device through the second indication information that a connection with all of DC cells and/or all of CA cells established by the terminal device is to be suspended, or a connection with all of remaining PSCell cells and/or all of remaining SCell cells is to be suspended, except for keeping a connection activation between the terminal device and a PCell cell.

As another example, the first message may contain a list of identifiers of DC/CA cells of which a connection is to be released (i.e., the first list information) and/or a list of identifiers of DC/CA cells of which a connection is to be suspended (i.e., the second list information). The number of first cells (i.e., DC/CA cells of which a connection is to be released) corresponding to the first list information may be one or more. The number of first cells (i.e., DC/CA cells of which a connection is to be suspended) corresponding to the second list information may also be one or more.

As another example, the first message may contain the third indication information for releasing and/or suspending a part of DC/CA cells, together with a list of identifiers of DC/CA cells of which a connection is to be released and/or a list of identifiers of DC/CA cells of which a connection is to be suspended.

Exemplarily, in the embodiment of the present disclosure, each of the at least one cell identifier includes at least one of: a serving cell index corresponding to a respective first cell, a Cell Global Identifier (CGI) corresponding to a respective first cell, or a frequency point and a Physical Cell Identifier (PCI) corresponding to a respective first cell. For example, the cell identifier is a serving cell index assigned by the network device or a CGI of the serving cell. For another example, the cell identifier includes a frequency point and a PCI of the serving cell.

### Second Example

The first message includes first request configuration information, and a value range of the first request configuration information includes at least one of:
a first value for indicating to the network device that a connection with all of the at least one first cell is to be released;
a second value for indicating to the network device that a connection with all of the at least one first cell is to be suspended; or
a third value for indicating to the network device that a connection with a part of the at least one first cell is to be released and/or a connection with a part of the at least one first cell is to be suspended.

Optionally, when the first request configuration information is the third value, the first message further includes first list information and/or second list information. The first list information includes at least one cell identifier of at least one first cell with which the terminal device requests a release of a connection; and the second list information includes at least one cell identifier of at least one first cell with which the terminal device requests a suspension of a connection.

For example, the first request configuration information may be two-bit information. The first value may be 00, the second value may be 01, and the third value may be 10. The value range of the first request configuration information may include {00, 01, 10, 11}. Here, 11 is reserved. When the value of the first request configuration information is 00, the first request configuration information corresponds to the first indication information, and indicates to the network device that a connection with all of the at least one first cell is to be released. When the value of the first request configuration information is 01, the first request configuration information corresponds to the second indication information, and indicates to the network device that a connection with all of the at least one first cell is to be suspended. When the value of the first request configuration information is 10, the first request configuration information corresponds to the third indication information, and indicates to the network device that a connection with a part of the at least one first cell is to be released and/or a connection with a part of the at least one first cell is to be suspended.

Optionally, the third value may include two values corresponding to the release of the connection and the suspension of the connection, respectively. That is, the third value includes a value for instructing the network device to release a connection with a part of the at least one first cell and a value for instructing the network device to suspend a connection with a part of the at least one first cell. For example, the first request configuration information may be two-bit information. The first value may be 00, the second value may be 01, and the third value may include 10 and 11. The value range of the first request configuration information may include {00, 01, 10, 11}. The value 10 is used to indicate to the network device that a connection with a part of the least one first cell is to be released, and the value 11 is used to indicate to the network device that a connection with a part of the least one first cell is to be suspended.

Optionally, the first message may further include reason information, and the reason information is used to indicate a reason triggering the terminal device to send the first message.

Optionally, the reason triggering the terminal device to send the first message includes at least one of the following:
other Subscriber Identification Module (SIM) cards in the terminal device supporting multiple SIM cards need to occupy resources;
interference occurs in the terminal device supporting multiple SIM cards; or the terminal device is overheated.

For example, the reason triggering the terminal device to send the first message may be a multi-card reason. That is, a connection with the DC/CA cell of the current SIM cannot be maintained because other SIMs in the multi-card terminal device need to occupy a part of the hardware resources of the terminal device. Failure of maintaining a connection can mean the need of releasing or suspending the connection. For another example, the reason triggering the terminal device to send the first message may be an intra-device interference reason, i.e., a connection with the DC/CA cell of the current SIM cannot be maintained due to intra-device interference of the multi-card terminal. For another example, the cause triggering the terminal device to send the first message may be that the terminal device is overheated. That is, a connection with at least a part of the DC/CA cells is to be released or suspended due to overheat of the terminal device.

Optionally, the first message may further include configuration information of a first timer.

During a running period of the first timer, the network device is prohibited from configuring and adding a new DC cell and/or a new CA cell for the terminal device; or during the running period of the first timer, the network device is prohibited from restoring a connection with a first cell that has been suspended for the terminal device.

The first timer may also be referred to as a DC/CA prohibition timer.

Exemplarily, the configuration information of the first timer may be used to indicate a timing duration of the first timer, so as to inform the network device of a duration during which configuration and addition of a DC/CA cell or a restoration of a DC/CA cell that has been suspended is not expected by the terminal device. During the running period of the first timer, the terminal device does not expect the network device to configure and add any DC/CA cells for the terminal device, or during the running period of the first timer, the terminal device does not expect the network device to restore a connection with any DC/CA cell that has been suspended for the terminal device.

Optionally, a starting rule of the first timer may be agreed in a pre-configured manner, such as a protocol default manner. Exemplarily, the starting rule of the first timer may be that the first timer is started upon receipt of configuration information or the first timer is started periodically, and the like.

Exemplarily, each of the at least one cell identifier includes at least one of: a serving cell index corresponding to a respective first cell, a CGI corresponding to a respective first cell, or a frequency point and a PCI corresponding to a respective first cell. For example, the cell identifier is a serving cell index assigned by the network device or a CGI of the serving cell. For another example, the cell identifier includes a frequency point and a PCI of the serving cell.

Optionally, the first message may be one of following messages:
a Radio Resource Control (RRC) message, a Medium Access Control Control Element (MAC CE) message, an Uplink Control Information (UCI) message, or a sequence type message.

Optionally, a sequence corresponding to the sequence type message is configured by a system broadcast message or a dedicated signaling.

For example, the first message includes the first indication information for indicating a release of a connection with all of DC/CA cells or the second indication information for indicating a suspension of a connection with all of DC/CA cells. The first message may be a pre-configured uplink sequence dedicated to carrying the first indication information or the second indication information. That is, the first indication information or the second indication information can be implicitly represented by the uplink sequence. The uplink sequence can be configured by a system broadcast message or a dedicated signaling.

Optionally, in some examples of the present disclosure, the network device may send a first message response message (hereinafter referred to as a response message of the first message) to the terminal device upon receipt of the first message. That is, after the network device receives the first message sent by the terminal device, the method may further include the following operation. The network device sends the response message of the first message to the terminal device. Accordingly, after the terminal device sends the first message to the network device, the method may further include the following operation. The terminal device receives the response message of the first message sent by the network device. The response message can be used to indicate to the terminal device whether the network device completely or partially accepts a request corresponding to the first message.

Optionally, the response message of the first message includes at least one of:
fourth indication information for indicating that a request corresponding to the first message is accepted;
fifth indication information for instructing the terminal device to release a connection with all of the at least one first cell;
sixth indication information for instructing the terminal device to suspend a connection with all of the at least one first cell;
third list information including at least one cell identifier of at least one first cell with which the network device agrees to release a connection; or
fourth list information including at least one cell identifier of at least one first cell with which the network device agrees to suspend a connection.

Exemplarily, the response message of the first message may include the fourth indication information for indicating that a content request by the first message from the terminal device is accepted by the network device. For example, when the first message includes the first indication information, the fourth indication information indicates that the network device agrees to release a connection with all of the at least one first cell. When the first message includes the second indication information, the fourth indication information indicates that the network device agrees to suspend a connection with all of the at least one first cell. When the first message includes the first list information and/or the second list information, the fourth indication information indicates that the network device agrees to release or suspend a connection with the DC/CA cell according to the first list information and/or the second list information.

Exemplarily, the response message of the first message may include the fifth indication information and/or sixth indication information. For example, regardless of the first message, the network device may instruct the terminal device to release a connection with all of DC/CA cells through the fifth indication information, or instruct the terminal device to suspend a connection with of all of DC/CA cells through the sixth indication information.

Exemplarily, the first uplink response message may include the third list information and/or fourth list information. For example, in a case that the first message contains the first list information and/or the second list information, and requests a release or suspension of a connection with multiple first cells; the network device may agree to release or suspend a connection with a part of the multiple first cells, and a cell identifier list of the first cells with which the network device agrees to release or suspend a connection is carried in the response message of the first message. The number of the first cells with which a connection is agreed to be released or suspended may be one or more.

Optionally, the response message of the first message may include configuration information of the second timer.

During a running period of the second timer, the terminal device is prohibited from requesting the network device to configure and add a new DC cell and/or a new CA cell; or during the running period of the second timer, the terminal device is prohibited from requesting the network device to restore a connection with a first cell that has been suspended.

The second timer can also be referred to as a DC/CA request prohibition timer. During a running period of the second timer, the terminal device cannot request the network device to restore a connection with a DC/CA cell that has been suspended or cannot request the network device to configure and add a new DC cell and/or a new CA cell. For example, when the DC cell configuration and addition prohibition or the CA cell configuration and addition prohibition is set, the DC/CA prohibition configuration prohibition cannot be lifted. The DC cell configuration and addition prohibition or the CA cell configuration and addition prohibition may be an instruction for prohibiting the configuration and addition of a new DC cell and/or a new CA cell.

Optionally, a starting rule of the second timer may be agreed in a pre-configured manner, such as a protocol default manner. Exemplarily, the starting rule of the second timer may be that the second timer is started upon receipt of configuration information or the second timer is started periodically, and the like.

Optionally, the response message of the first message may be an RRC message, a Radio Link Control (RLC) control message, a MAC CE message, or a Downlink Control Information (DCI) message.

Optionally, after the terminal device sends the first message to the network device, the method can further include the following operation. When the terminal device does not receive a response message from the network device within a preset duration after sending the first message, the terminal device autonomously releases or suspends the connection with the at least one first cell.

That is, the terminal device can monitor, from the network device, the response message, such as the response message of the first message, within a preset duration. If the response message is received within the preset duration, the monitoring can be stopped. If the response message is not monitored all the time in the preset duration, the terminal device can autonomously release or suspend the connection with the at least one first cell.

Exemplarily, the preset duration is configured in a pre-configured manner, such as in a protocol-agreed manner, configured through a cell system broadcast message, or configured through a dedicated signaling from the network device. For example, the preset duration can be a default duration that is pre-configured. For another example, the preset duration may be a duration of a timer configured by a cell system broadcast message or a dedicated signaling from the network device.

Correspondingly, the method can further include the following operation. The network device sends configuration information of a preset duration to the terminal device. The preset duration is a maximum time for the terminal device to monitor the response message of the first message after sending the first message. Optionally, the configuration information of the preset duration may be sent through being carried in a cell system broadcast message or a dedicated signaling. Optionally, the preset duration may be pre-configured, such as protocol-agreed.

Optionally, when a connection with one or more cells is suspended, the terminal device may request a restoration of the cell that has been suspended. Optionally, when the terminal device and/or the network device are configured with a DC cell configuration and addition prohibition or a CA cell configuration and addition prohibition, the terminal device may request a lifting of the DC cell configuration and addition prohibition or the CA cell configuration and addition prohibition. Specifically, the above method may include the following operations.

The terminal device sends a second message to the network device; and/or the network device receives the second message from the terminal device.

The second message is used to request a restoration of a connection with at least one first cell that has been suspended, and/or to request the network device to lift a DC cell configuration and addition prohibition or a CA cell configuration and addition prohibition.

Exemplarily, the DC cell configuration and addition prohibition or the CA cell configuration and addition prohibition may include an instruction for prohibiting the network device from configuring and adding a new DC cell and/or a new CA cell, and may further include an instruction for prohibiting the terminal device from requesting configuration and addition of a new DC cell and/or a new CA cell. The new cell may include a cell that has not been configured and added before, or a cell that has been configured and added but has been released.

Optionally, the second message includes at least one of:
seventh indication information for requesting a lifting of the DC cell configuration and addition prohibition or for requesting a lifting of a DC cell connection restoration prohibition;
eighth indication information for requesting a lifting of the CA cell configuration and addition prohibition or for requesting a lifting of a CA cell connection restoration prohibition;
ninth indication information for requesting a lifting of the DC cell configuration and addition prohibition or the CA cell configuration and addition prohibition or for requesting a lifting of a DC cell connection restoration prohibition or a CA cell connection restoration prohibition; or
tenth indication information for requesting a restoration of a connection with at least one first cell that has been suspended.

Exemplarily, the second message may include the seventh indication information for requesting a lifting of a prohibition on the DC function. The DC cell configuration and addition prohibition is an instruction for prohibiting configuration and addition of a new DC cell. After the DC cell configuration and addition prohibition is lifted, the network device can configure and add a new DC cell for the terminal device. The DC cell connection restoration prohibition is an instruction for prohibiting a restoration of a DC cell that has been suspended. After the DC cell connection restoration prohibition is lifted, the terminal device can request a restoration of a connection with a DC cell that has been suspended.

Exemplarily, the second message may include the eighth indication information for requesting a lifting of a prohibition on the CA function. The CA cell configuration and addition prohibition is an instruction for prohibiting configuration and addition of a new CA cell. After the CA cell configuration and addition prohibition is lifted, the network device can configure and add a new CA cell for the terminal device. The CA cell connection restoration prohibition is an instruction for prohibiting a restoration of a CA cell that has been suspended. After the CA cell connection restoration prohibition is lifted, the terminal device can request a restoration of a connection with a CA cell that has been suspended.

Exemplarily, the second message may include the ninth indication information for simultaneously requesting a lifting of a prohibition on both DC and CA functions. The DC/CA cell configuration and addition prohibition is an instruction for prohibiting configuration and addition of a new DC cell and prohibiting addition of a new CA cell. After the DC/CA cell configuration and addition prohibition is lifted, the network device can configure and add a new DC/CA cell for the terminal device. The DC/CA cell connection restoration prohibition is an instruction for prohibiting a restoration of a DC cell that has been suspended and prohibiting a restoration of a CA cell that has been suspended. After the DC/CA cell connection restoration prohibition is lifted, the terminal device can request a restoration of a connection with a DC/CA cell that has been suspended.

Exemplarily, the second message may include the tenth indication information. For example, when a cell connection restoration prohibition is not configured, the terminal device may send the second message carrying the tenth indication message for requesting a restoration of a connection with the first cell that has been suspended.

Optionally, the various prohibitions may be sent in the first message, the response message of the first message, or may be sent in other messages or obtained according to a predetermined rule.

Optionally, the second message is one of following messages:
an RRC message, a MAC CE message, an UCI message, or a sequence type message.

Optionally, a sequence corresponding to the sequence type message is configured by a system broadcast message or a dedicated signaling.

For example, the second message may be a pre-configured uplink sequence dedicated to carrying the seventh indication information, the eighth indication information, the ninth indication information or the tenth indication information. That is, the indication information can be implicitly represented by the uplink sequence. The uplink sequence can be configured by a system broadcast message or a dedicated signaling.

Optionally, in the embodiments of the present disclosure, the terminal device may determine whether the first message can be sent based on the configuration of the network device. Specifically, the method may include the following operations.

The network device sends downlink configuration information to the terminal device; and/or the terminal device receives the downlink configuration information sent by the network device.

The downlink configuration information includes first capability configuration information, and the first capability configuration information is used to indicate whether the terminal device is allowed to request a release or suspension of the connection with the at least one first cell.

Exemplarily, when a value of the first capability configuration information is allowance, the terminal device is allowed to request the network device to release or suspend a connection with a DC cell and/or a CA cell through the first message. When the value of the first capability configuration information is no allowance, the terminal device is not allowed to request the network device to release or suspend a connection with a DC cell and/or a CA cell through the first message.

Optionally, the downlink configuration information may further include configuration information of a third timer, during a running period of the third timer, the terminal device is prohibited from sending the first message to the network device. Exemplarily, even if the first capability configuration information sent by the network device indicates that the terminal device is allowed to request a release or suspension of a connection with the first cell, the terminal device cannot send the first message during the running period of the third timer. That is, the third timer is used to prohibit the terminal device from frequently requesting a release or suspension of a connection with the DC cell and/or the CA cell. By configuring the third timer, the overhead of uplink signaling caused by the terminal device frequently requesting a release or suspension of a connection with the DC/CA cell can be avoided.

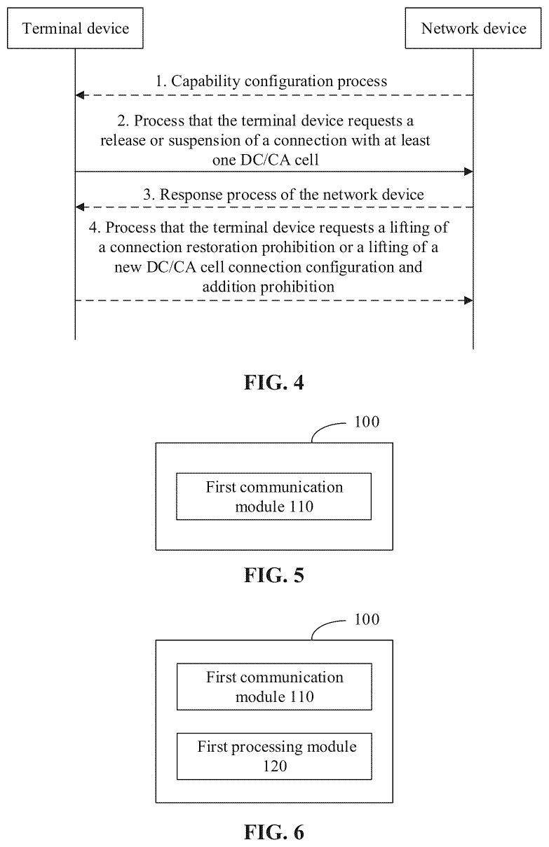

FIG. 4 illustrates an application example of a method for connection control according to an embodiment of the present disclosure. It should be noted that respective operations can be optional rather than mandatory. As illustrated in FIG. 4, the method for connection control may include at least one of the following operations.

First operation: a capability configuration process. The network device sends downlink configuration information to the terminal device, to indicate whether the terminal device is allowed to request a release or suspension of a connection with at least one DC/CA cell.

Second operation: a process that the terminal device requests a release or suspension of a connection with the at least one DC/CA cell. The terminal device sends the first message to the network device, to indicate to the network device that a connection with the at least one DC/CA cell is to be released or suspended.

Third operation: a response process of the network device. The network device sends a response message of the first message to the terminal device, to indicate that all requests corresponding to the first message are accepted, all requests corresponding to the first message are not accepted or a part of requests corresponding to the first message is accepted.

Fourth operation: a process that the terminal device requests a lifting of a connection restoration prohibition or a lifting of a new DC/CA cell connection configuration and addition prohibition. When the connection restoration prohibition or the new DC/CA cell connection configuration and addition prohibition is configured, that is, when a restoration of a connection with the DC/CA cell (restoration of a connection with the DC/CA cell that has been suspended) is prohibited, or a configuration and addition of the new DC/CA cell connection is prohibited, the terminal device can send the second message to the network device for requesting a lifting of the prohibition.

The downlink configuration information, the first message, the response message of the first message, and the second message can be implemented with reference to the foregoing embodiments which will not be described here.

Corresponding to the processing method of at least one embodiment described above, the embodiment of the present disclosure further provides a terminal device 100. Referring to FIG. 5, the terminal device 100 includes a first communication module 110.

The first communication module 110 is configured to send a first message to a network device. The first message is used to request a release or suspension of a connection with at least one first cell, and the at least one first cell includes at least one Dual Connectivity (DC) cell and/or at least one Carrier Aggregation (CA) cell.

Optionally, the first message includes at least one of: first indication information for indicating to the network device that a connection with all of the at least one first cell is to be released; second indication information for indicating to the network device that a connection with all of the at least one first cell is to be suspended; third indication information for indicating to the network device that a connection with a part of the at least one first cell is to be released and/or a connection with a part of the at least one first cell is to be suspended; first list information including at least one cell identifier of at least one first cell with which the terminal device requests a release of a connection; or second list information including at least one cell identifier of at least one first cell with which the terminal device requests a suspension of a connection.

Optionally, the first message includes first request configuration information, and a value range of the first request configuration information includes at least one of: a first value for indicating to the network device that a connection with all of the at least one first cell is to be released; a second value for indicating to the network device that a connection with all of the at least one first cell is to be suspended; or a third value for indicating to the network device that a connection with a part of the at least one first cell is to be released and/or a connection with a part of the at least one first cell is to be suspended.

Optionally, when the first request configuration information is the third value, the first message further includes first list information and/or second list information.

The first list information includes at least one cell identifier of at least one first cell with which the terminal device requests a release of a connection; and the second list information includes at least one cell identifier of at least one first cell with which the terminal device requests a suspension of a connection.

Optionally, the first message includes reason information, and the reason information is used to indicate a reason triggering the terminal device to send the first message.

Optionally, the reason triggering the terminal device to send the first message includes at least one of the following: other Subscriber Identification Module (SIM) cards in the terminal device supporting multiple SIM cards need to occupy resources; interference occurs in the terminal device supporting multiple SIM cards; or the terminal device is overheated.

Optionally, the first message includes configuration information of a first timer.

During a running period of the first timer, the network device is prohibited from configuring and adding a new DC cell and/or a new CA cell for the terminal device; or during the running period of the first timer, the network device is prohibited from restoring a connection with a first cell that has been suspended for the terminal device.

Optionally, the first communication module 110 is further configured to: receive a response message of the first message from the network device.

Optionally, the response message of the first message includes at least one of: fourth indication information for indicating that a request corresponding to the first message is accepted; fifth indication information for instructing the terminal device to release a connection with all of the at least one first cell; sixth indication information for instructing the terminal device to suspend a connection with all of the at least one first cell; third list information including at least one cell identifier of at least one first cell with which the network device agrees to release a connection; or fourth list information including at least one cell identifier of at least one first cell with which the network device agrees to suspend a connection.

Optionally, each of the at least one cell identifier includes at least one of: a serving cell index corresponding to a respective first cell, a Cell Global Identifier (CGI) corresponding to a respective first cell, or a frequency point and a Physical Cell Identifier (PCI) corresponding to a respective first cell.

Optionally, the response message of the first message includes configuration information of a second timer.

During a running period of the second timer, the terminal device is prohibited from requesting the network device to configure and add a new DC cell and/or a new CA cell; or during the running period of the second timer, the terminal device is prohibited from requesting the network device to restore a connection with a first cell that has been suspended.

Optionally, the response message of the first message is a Radio Resource Control (RRC) message, a Radio Link Control (RLC) control message, a Medium Access Control Control Element (MAC CE) message, or a Downlink Control Information (DCI) message.

Optionally, as illustrated in FIG. 6, the terminal device further includes a first processing module 120.

The first processing module 120 is configured to: when the terminal device does not receive a response message from the network device within a preset duration after sending the first message, release or suspend autonomously the connection with the at least one first cell.

Optionally, the preset duration is configured in a pre-configured manner, configured through a cell system broadcast message, or configured through a dedicated signaling from the network device.

Optionally, the first communication module 110 is further configured to: send a second message to the network device. The second message is used to request a restoration of a connection with at least one first cell that has been suspended, and/or to request the network device to lift a DC cell configuration and addition prohibition or a CA cell configuration and addition prohibition.

Optionally, the second message includes at least one of: seventh indication information for requesting a lifting of the DC cell configuration and addition prohibition or for requesting a lifting of a DC cell connection restoration prohibition; eighth indication information for requesting a lifting of the CA cell configuration and addition prohibition or for requesting a lifting of a CA cell connection restoration prohibition; or ninth indication information for requesting a lifting of the DC cell configuration and addition prohibition or the CA cell configuration and addition prohibition or for requesting a lifting of a DC cell connection restoration prohibition or a CA cell connection restoration prohibition; or tenth indication information for requesting a restoration of a connection with at least one first cell that has been suspended.

Optionally, the second message is one of following messages: a Radio Resource Control (RRC) message, a Medium Access Control Control Element (MAC CE) message, an Uplink Control Information (UCI) message, or a sequence type message.

Optionally, the first message is one of following messages: a Radio Resource Control (RRC) message, a Medium Access Control Control Element (MAC CE) message, an Uplink Control Information (UCI) message, or a sequence type message.

Optionally, a sequence corresponding to the sequence type message is configured by a system broadcast message or a dedicated signaling.

Optionally, the first communication module 110 is further configured to: receive downlink configuration information from the network device. The downlink configuration information includes first capability configuration information, and the first capability configuration information is used to indicate whether the terminal device is allowed to request a release or suspension of the connection with the at least one first cell.

Optionally, the downlink configuration information further includes configuration information of a third timer, and during a running period of the third timer, the terminal device is prohibited from sending the first message to the network device.

The terminal device 100 of the embodiment of the present disclosure can implement the corresponding function of the terminal device in the method embodiment. For the corresponding flows, functions, implementation modes and beneficial effects of various modules (sub-modules, units or components, etc.) in the terminal device 100, reference may be made to the corresponding description in the method embodiment which will not be described here. It should be noted that the functions described by various modules (sub-modules, units or components, etc.) in the terminal device 100 of the embodiment of the present disclosure can be implemented by different modules (sub-modules, units or components, etc.) or by the same module (sub-module, unit or component, etc.). For example, the first communication module and the second communication module can be different modules or the same module, and can implement corresponding functions in the embodiment of the present disclosure. In addition, the communication module in the embodiment of the present disclosure can be implemented by a transceiver of a device, and some or all of the remaining modules can be implemented by a processor of the device.

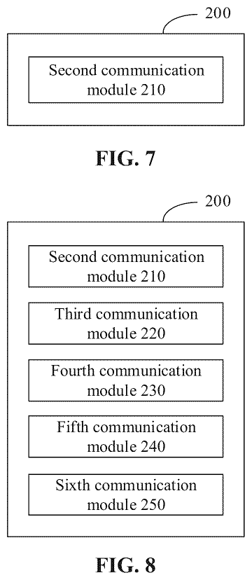

FIG. 7 is a schematic block diagram of a network device 200 according to an embodiment of the present disclosure. The network device 200 may include a second communication module 210.

The second communication module 210 is configured to receive a first message from a terminal device. The first message is used to request a release or suspension of a connection with at least one first cell, and the at least one first cell includes at least one Dual Connectivity (DC) cell and/or at least one Carrier Aggregation (CA) cell.

Optionally, the first message includes at least one of: first indication information for indicating to the network device that a connection with all of the at least one first cell is to be released; second indication information for indicating to the network device that a connection with all of the at least one first cell is to be suspended; third indication information for indicating to the network device that a connection with a part of the at least one first cell is to be released and/or a connection with a part of the at least one first cell is to be suspended; first list information including at least one cell identifier of at least one first cell with which the terminal device requests a release of a connection; or second list information including at least one cell identifier of at least one first cell with which the terminal device requests a suspension of a connection.

Optionally, the first message includes first request configuration information, and a value range of the first request configuration information includes at least one of: a first value for indicating to the network device that a connection with all of the at least one first cell is to be released; a second value for indicating to the network device that a connection with all of the at least one first cell is to be suspended; or a third value for indicating to the network device that a connection with a part of the at least one first cell is to be released and/or a connection with a part of the at least one first cell is to be suspended.

Optionally, when the first request configuration information is the third value, the first message further includes first list information and/or second list information.

The first list information includes at least one cell identifier of at least one first cell with which the terminal device requests a release of a connection; and the second list information includes at least one cell identifier of at least one first cell with which the terminal device requests a suspension of a connection.

Optionally, the first message includes reason information, and the reason information is used to indicate a reason triggering the terminal device to send the first message.

Optionally, the reason triggering the terminal device to send the first message includes at least one of the following: other Subscriber Identification Module (SIM) cards in the terminal device supporting multiple SIM cards need to occupy resources; interference occurs in the terminal device supporting multiple SIM cards; or the terminal device is overheated.

Optionally, the first message includes configuration information of a first timer.

During a running period of the first timer, the network device is prohibited from configuring and adding a new DC cell and/or a new CA cell for the terminal device; or during the running period of the first timer, the network device is prohibited from restoring a connection with a first cell that has been suspended for the terminal device.

Optionally, as illustrated in FIG. 8, the network device 200 further includes a third communication module 220.

The third communication module 220 is configured to send a response message of the first message to the terminal device.

Optionally, the response message of the first message includes at least one of: fourth indication information for indicating that a request corresponding to the first message is accepted; fifth indication information for instructing the terminal device to release a connection with all of the at least one first cell; sixth indication information for instructing the terminal device to suspend a connection with all of the at least one first cell; third list information including at least one cell identifier of at least one first cell with which the network device agrees to release a connection; or fourth list information including at least one cell identifier of at least one first cell with which the network device agrees to suspend a connection.

Optionally, each of the at least one cell identifier includes at least one of: a serving cell index corresponding to a respective first cell, a Cell Global Identifier (CGI) corresponding to a respective first cell, or a frequency point and a Physical Cell Identifier (PCI) corresponding to a respective first cell.

Optionally, the response message of the first message includes configuration information of a second timer.

During a running period of the second timer, the terminal device is prohibited from requesting the network device to configure and add a new DC cell and/or a new CA cell; or during the running period of the second timer, the terminal device is prohibited from requesting the network device to restore a connection with a first cell that has been suspended.

Optionally, the response message of the first message is a Radio Resource Control (RRC) message, a Radio Link Control (RLC) control message, a Medium Access Control Control Element (MAC CE) message, or a Downlink Control Information (DCI) message.

Optionally, as illustrated in FIG. 8, the network device 200 further includes a fourth communication module 230.

The fourth communication module 230 is configured to send configuration information of a preset duration to the terminal device. The preset duration is a maximum duration for the terminal device to monitor the response message of the first message after sending the first message.

Optionally, the configuration information of the preset duration is sent through being carried in a cell system broadcast message or a dedicated signaling.

Optionally, as illustrated in FIG. 8, the network device 200 further includes a fifth communication module 240.

The fifth communication module 240 is configured to receive a second message from a terminal device. The second message is used to request a restoration of a connection with at least one first cell that has been suspended, and/or to request the network device to lift a DC cell configuration and addition prohibition or a CA cell configuration and addition prohibition.

Optionally, the second message includes at least one of: seventh indication information for requesting a lifting of the DC cell configuration and addition prohibition or for requesting a lifting of a DC cell connection restoration prohibition; eighth indication information for requesting a lifting of the CA cell configuration and addition prohibition or for requesting a lifting of a CA cell connection restoration prohibition; or ninth indication information for requesting a lifting of the DC cell configuration and addition prohibition or the CA cell configuration and addition prohibition or for requesting a lifting of a DC cell connection restoration prohibition or a CA cell connection restoration prohibition; or tenth indication information for requesting a restoration of a connection with at least one first cell that has been suspended.

Optionally, the second message is one of following messages: a Radio Resource Control (RRC) message, a Medium Access Control Control Element (MAC CE) message, an Uplink Control Information (UCI) message, or a sequence type message.

Optionally, the first message is one of following messages: a Radio Resource Control (RRC) message, a Medium Access Control Control Element (MAC CE) message, an Uplink Control Information (UCI) message, or a sequence type message.

Optionally, a sequence corresponding to the sequence type message is configured by a system broadcast message or a dedicated signaling.

Optionally, as illustrated in FIG. 8, the network device further includes a sixth communication module 250.

The sixth communication module 250 is configured to send downlink configuration information to the terminal device. The downlink configuration information includes first capability configuration information, and the first capability configuration information is used to indicate whether the terminal device is allowed to request a release or suspension of the connection with the at least one first cell.

Optionally, the downlink configuration information further includes configuration information of a third timer, and during a running period of the third timer, the terminal device is prohibited from sending the first message to the network device.

The network device 200 of the embodiment of the present disclosure can implement the corresponding function of the network device in the method embodiment. For the corresponding flows, functions, implementation modes and beneficial effects of various modules (sub-modules, units or components, etc.) in the network device 200, reference may be made to the corresponding description in the method embodiment which will not be described here. It should be noted that the functions described by various modules (sub-modules, units or components, etc.) in the network device 200 of the embodiment of the present disclosure can be implemented by different modules (sub-modules, units or components, etc.) or by the same module (sub-module, unit or component, etc.). For example, the first communication module and the second communication module can be different modules or the same module, and can implement corresponding functions in the embodiment of the present disclosure. In addition, the communication module in the embodiment of the present disclosure can be implemented by a transceiver of a device, and some or all of the remaining modules can be implemented by a processor of the device.

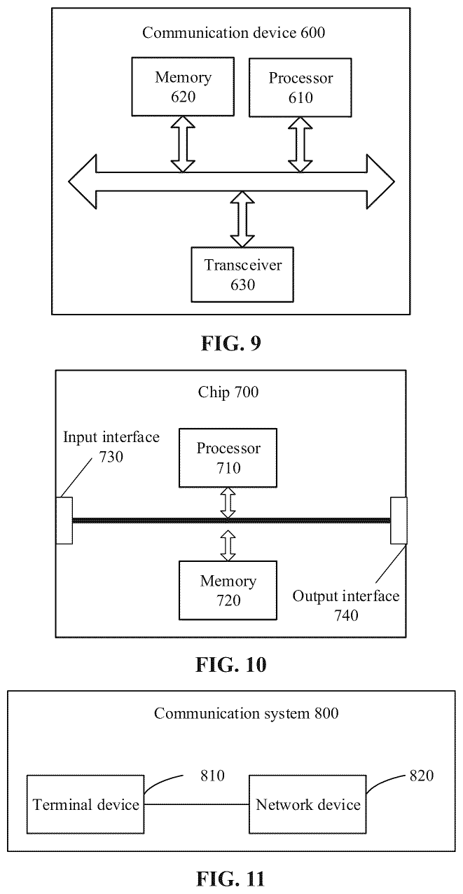

FIG. 9 is a schematic diagram of a structure of a communication device 600 according to an embodiment of the present disclosure. The communication device 600 includes a processor 610 that can call and run a computer program from a memory to implement the method in the embodiment of the present disclosure.

Optionally, the communication device 600 may further include a memory 620. The processor 610 may call and run a computer program from the memory 620 to implement the methods in the embodiments of the present disclosure.

The memory 620 may be a separate device independent of the processor 610 or may be integrated in the processor 610.

Optionally, the communication device 600 may further include a transceiver 630. The processor 610 may control the transceiver 630 to communicate with other devices. Specifically, the processor 610 may control the transceiver 630 to send information or data to other devices or receive information or data sent by other devices.

The transceiver 630 may include a transmitter and a receiver. The transceiver 630 may further include antennas, the number of which may be one or more.

Optionally, the communication device 600 may be the network device according to the embodiment of the present disclosure, and the communication device 600 may implement corresponding flows implemented by the network device in various methods of the embodiments of the present disclosure, which will not be repeated here for the sake of brevity.

Optionally, the communication device 600 may be the terminal device according to the embodiment of the present disclosure and the communication device 600 may implement corresponding flows implemented by the terminal device in various methods of the embodiments of the present disclosure, which will not be repeated here for the sake of brevity.

FIG. 10 is a schematic diagram of a structure of a chip 700 according to an embodiment of the present disclosure. The chip 700 includes a processor 710 that can call and run a computer program from a memory to implement the methods in the embodiments of the present disclosure.

Optionally, the chip 700 may further include a memory 720. The processor 710 may call and run a computer program from the memory 720 to implement the methods in the embodiments of the present disclosure.

The memory 720 may be a separate device independent of the processor 710 or may be integrated in the processor 710.

Optionally, the chip 700 may further include an input interface 730. The processor 710 may control the input interface 730 to communicate with other devices or chips. Specifically, the processor 710 may control the input interface 730 to obtain information or data sent by other devices or chips.

Optionally, the chip 700 may further include an output interface 740. The processor 710 may control the output interface 740 to communicate with other devices or chips. Specifically, the processor 710 may control the output interface 740 to output information or data to other devices or chips.

Optionally, the chip can be applied to the network device in the embodiments of the present disclosure, and the chip can implement corresponding flows implemented by the network device in various methods of the embodiments of the present disclosure, which will not repeated here for the sake of brevity.

Optionally, the chip can be applied to the terminal device in the embodiments of the present disclosure, and the chip can implement corresponding flows implemented by the terminal device in various methods of the embodiment of the present disclosure, which will not be repeated here for the sake of brevity.

It should be understood that the chips referred to in the embodiments of the present disclosure may also be referred to as a system level chip, a system chip, a chip system, a chip-on system or the like.

The processor mentioned above may be a general purpose processor, a digital signal processor (DSP), a field programmable gate array (FPGA), an application specific integrated circuit (ASIC), or other programmable logic devices, transistor logic devices, discrete hardware components, and the like. The general purpose processor mentioned above may be a microprocessor or any conventional processor or the like.

The memory mentioned above may be a volatile memory or a non-volatile memory or may include both a volatile memory and a non-volatile memory. The non-volatile memory may be a read-only memory (ROM), a programmable ROM (PROM), an erasable PROM (EPROM), an electrically EPROM (EPROM) or a flash memory. The volatile memory may be a random access memory (RAM).

It should be understood that the memory described above is exemplary, but not restrictive. For example, the memory in the embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), or a direct rambus RAM (DR RAM), and the like. That is to say, the memory in the embodiments of the present disclosure is intended to include, but not limited to, these and any other memories with suitable types.

FIG. 11 is a schematic block diagram of a communication system 800 according to an embodiment of the present disclosure. The communication system 800 includes a terminal device 810 and a network device 820.

The terminal device 810 sends a first message to the network device 820. The network device 820 receives the first message. The first message is used to request a release or suspension of a connection with at least one first cell, and the at least one first cell includes at least one Dual Connectivity (DC) cell and/or at least one Carrier Aggregation (CA) cell.

The terminal device 810 may be used to implement corresponding functions implemented by the terminal device in the methods of various embodiments of the present disclosure, and the network device 820 may be used to implement corresponding functions implemented by the network device in the methods of various embodiments of the present disclosure. For the sake of brevity, details will not be repeated here.

The above-described embodiment may be implemented in whole or in part by software, hardware, firmware or any combination thereof. When implemented in software, it can be implemented in whole or in part in the form of a computer program product. The computer program product includes one or more computer instructions. When the computer program instructions are loaded and executed on a computer, flows or functions according to the embodiments of the present disclosure are generated in whole or in part. The computer may be a general purpose computer, a special purpose computer, a computer network, or other programmable devices. The computer instructions may be stored in a computer-readable storage medium or transmitted from one computer-readable storage medium to another computer-readable storage medium. For example, the computer instructions may be transmitted from one web site, one computer, one server, or one data center to another web site, another computer, another server, or another data center in a wired (e.g., coaxial cable, optical fiber, Digital Subscriber Line (DSL)) or wireless (e.g., infrared, wireless, microwave, etc.) manner. The computer-readable storage medium may be any usable medium accessible to a computer or a data storage device, such as a server, a data center and the like containing one or more usable media integration. The usable medium may be a magnetic medium (e.g., floppy disk, hard disk, magnetic tape), an optical medium (e.g., Digital Video Disc (DVD)), or a semiconductor medium (e.g., Solid State Disk (SSD)), etc.

It should be understood that in various embodiments of the present disclosure, the size of the sequence number of the above-mentioned processes does not mean the order of execution, and the execution order of various processes should be determined by its function and inherent logic, and should not be limited in any way to the implementation process of the embodiments of the present disclosure.

Those skilled in the art will clearly appreciate that, for convenience and conciseness of description, for the specific operating processes of the above-described systems, apparatuses and units, reference may be made to the corresponding flows in the aforementioned method embodiments which will not be repeated herein.

The foregoing descriptions are merely specific embodiments of the present disclosure, but the protection scope of the present disclosure is not limited thereto. Any change or substitution that is readily conceived of by a person skilled in the art within the technical scope disclosed in the present disclosure shall fall within the protection scope of the present disclosure. Therefore, the protection scope of the present disclosure shall be subject to the protection scope of the claims.

1. A method for connection control, comprising:
sending, by a terminal device, a first message to a network device, wherein the first message is used to request a release or suspension of a connection with at least one first cell, and the at least one first cell comprises at least one Dual Connectivity (DC) cell and/or at least one Carrier Aggregation (CA) cell.

2. The method of claim 1, wherein the first message comprises at least one of:
first indication information for indicating to the network device that a connection with all of the at least one first cell is to be released;
second indication information for indicating to the network device that a connection with all of the at least one first cell is to be suspended;
third indication information for indicating to the network device that a connection with a part of the at least one first cell is to be released and/or a connection with a part of the at least one first cell is to be suspended;
first list information comprising at least one cell identifier of at least one first cell with which the terminal device requests a release of a connection; or
second list information comprising at least one cell identifier of at least one first cell with which the terminal device requests a suspension of a connection.

3. The method of claim 1, wherein the first message comprises first request configuration information, and a value range of the first request configuration information comprises at least one of:
a first value for indicating to the network device that a connection with all of the at least one first cell is to be released;
a second value for indicating to the network device that a connection with all of the at least one first cell is to be suspended; or
a third value for indicating to the network device that a connection with a part of the at least one first cell is to be released and/or a connection with a part of the at least one first cell is to be suspended.

4. The method of claim 3, wherein when the first request configuration information is the third value, the first message further comprises first list information and/or second list information;
wherein the first list information comprises at least one cell identifier of at least one first cell with which the terminal device requests a release of a connection; and the second list information comprises at least one cell identifier of at least one first cell with which the terminal device requests a suspension of a connection.

5. The method of claim 1, wherein the first message comprises reason information, and the reason information is used to indicate a reason triggering the terminal device to send the first message.

6. The method of claim 5, wherein the reason triggering the terminal device to send the first message comprises at least one of the following:
other Subscriber Identification Module (SIM) cards in the terminal device supporting multiple SIM cards need to occupy resources;
interference occurs in the terminal device supporting multiple SIM cards; or
the terminal device is overheated.

7. The method of claim 1, wherein the first message comprises configuration information of a first timer;
during an operation of the first timer, the network device is prohibited from configuring and adding a new DC cell and/or a new CA cell for the terminal device; or during the operation of the first timer, the network device is prohibited from restoring a connection with a first cell that has been suspended for the terminal device.

8. A terminal device, comprising: a processor and a memory for storing a computer program, wherein the processor is configured to call and run the computer program stored in the memory to cause the terminal device to:
send a first message to a network device, wherein the first message is used to request a release or suspension of a connection with at least one first cell, and the at least one first cell comprises at least one Dual Connectivity (DC) cell and/or at least one Carrier Aggregation (CA) cell.

9. The terminal device of claim 8, wherein the first message comprises at least one of:
first indication information for indicating to the network device that a connection with all of the at least one first cell is to be released;
second indication information for indicating to the network device that a connection with all of the at least one first cell is to be suspended;
third indication information for indicating to the network device that a connection with a part of the at least one first cell is to be released and/or a connection with a part of the at least one first cell is to be suspended;
first list information comprising at least one cell identifier of at least one first cell with which the terminal device requests a release of a connection; or
second list information comprising at least one cell identifier of at least one first cell with which the terminal device requests a suspension of a connection.

10. The terminal device of claim 8, wherein the first message comprises first request configuration information, and a value range of the first request configuration information comprises at least one of:
a first value for indicating to the network device that a connection with all of the at least one first cell is to be released;
a second value for indicating to the network device that a connection with all of the at least one first cell is to be suspended; or
a third value for indicating to the network device that a connection with a part of the at least one first cell is to be released and/or a connection with a part of the at least one first cell is to be suspended.

11. The terminal device of claim 10, wherein when the first request configuration information is the third value, the first message further comprises first list information and/or second list information;
wherein the first list information comprises at least one cell identifier of at least one first cell with which the terminal device requests a release of a connection; and the second list information comprises at least one cell identifier of at least one first cell with which the terminal device requests a suspension of a connection.

12. The terminal device of claim 8, wherein the first message comprises reason information, and the reason information is used to indicate a reason triggering the terminal device to send the first message.

13. The terminal device of claim 12, wherein the reason triggering the terminal device to send the first message comprises at least one of the following:
other Subscriber Identification Module (SIM) cards in the terminal device supporting multiple SIM cards need to occupy resources;
interference occurs in the terminal device supporting multiple SIM cards; or
the terminal device is overheated.

14. The terminal device of claim 8, wherein the processor is further configured to cause the terminal device to:
receive a response message of the first message from the network device.

15. A network device, comprising: a processor and a memory for storing a computer program, wherein the processor is configured to call and run the computer program stored in the memory to cause the network device to:
receive a first message from a terminal device, wherein the first message is used to request a release or suspension of a connection with at least one first cell, and the at least one first cell comprises at least one Dual Connectivity (DC) cell and/or at least one Carrier Aggregation (CA) cell.

16. The network device of claim 15, wherein the first message comprises at least one of:
first indication information for indicating to the network device that a connection with all of the at least one first cell is to be released;
second indication information for indicating to the network device that a connection with all of the at least one first cell is to be suspended;
third indication information for indicating to the network device that a connection with a part of the at least one first cell is to be released and/or a connection with a part of the at least one first cell is to be suspended;
first list information comprising at least one cell identifier of at least one first cell with which the terminal device requests a release of a connection; or
second list information comprising at least one cell identifier of at least one first cell with which the terminal device requests a suspension of a connection.

17. The network device of claim 16, wherein each of the at least one cell identifier comprises at least one of: a serving cell index corresponding to a respective first cell, a Cell Global Identifier (CGI) corresponding to a respective first cell, or a frequency point and a Physical Cell Identifier (PCI) corresponding to a respective first cell.

18. The network device of claim 15, wherein the processor is further configured to cause the network device to:
send configuration information of a preset duration to the terminal device, wherein the preset duration is a maximum duration for the terminal device to monitor the response message of the first message after sending the first message;
wherein the configuration information of the preset duration is sent through being carried in a cell system broadcast message or a dedicated signaling.

19. The network device of claim 15, wherein the processor is further configured to cause the network device to:
send downlink configuration information to the terminal device, wherein the downlink configuration information comprises first capability configuration information, and the first capability configuration information is used to indicate whether the terminal device is allowed to request a release or suspension of the connection with the at least one first cell.

20. The network device of claim 19, wherein the downlink configuration information further comprises configuration information of a third timer, and during an operation of the third timer, the terminal device is prohibited from sending the first message to the network device.
